(19) United States
(12) Patent Application Publication
(10) Pub. No.: US 2007/0146123 A1
(43) Pub. Date: Jun. 28, 2007

(54) Multi-tone back-up alarm

(75) Inventors: Dale C. Hessing, Eagle, ID (US); Grant C. Juel, Boise, ID (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Preco Electronics, Inc., Boise, ID (US)

(21) Appl. No.: 11/317,884

(22) Filed: Dec. 22, 2005

(51) Int. Cl. G08B 3/10; B60Q 1/22

(52) U.S. Cl. 340/384.4; 340/384.7; 340/463

(57) ABSTRACT

A multi-tone vehicle motion alarm is provided as an augmentation of a single-tone alarm by imbedding in the alarm sound a plurality band-limited single-tone acoustic signals of different frequencies that are emitted in pulsed synchronism so that the warning signal is emitted in a form that allows directionality of the source to be determined by those around the alarmed equipment. This functional extension preserves many of the familiar aspects of existing alarms. Further, limiting the frequency band of the alarm reduces useless noise in the worksite. The preferred embodiment emits a pulsating tone alarm consisting of two discrete and identifiable monotones. The alarm is an extension of widely recognized pulsating reverse warning sounds. Additional tones may be employed to aid in the speed with which the sound source can be located with human hearing.

### CROSS-REFERENCES TO RELATED APPLICATIONS

NOT APPLICABLE

### STATEMENT AS TO RIGHTS TO INVENTIONS MADE UNDER FEDERALLY SPONSORED RESEARCH OR DEVELOPMENT

NOT APPLICABLE

REFERENCE TO A “SEQUENCE LISTING,” A TABLE, OR A COMPUTER PROGRAM LISTING APPENDIX SUBMITTED ON A COMPACT DISK.

NOT APPLICABLE

### BACKGROUND OF THE INVENTION

The present invention relates to motion alarms, and more particularly to techniques for generating warning sounds for use in moving vehicles.

Most vehicle back-up alarms in use today employ an acoustic transducer (speaker) driven from a low-pulsing rate modulated tone generator. The audible sound generated (“beep beep” alarm) is widely recognized, whether or not involved in the worksite.

To improve existing warning alarms, it is desirable to increase the listener's ability to identify the source direction of the alarm sound. A variety of studies have demonstrated that human hearing is better able to derive direction or source location of sound with reference to rich tonal content of the sound. Moreover, it has been observed that the human brain is able to identify peaks and nulls in sound patterns due to the fixed separation of human ears. This is believed to be the result of multiple frequencies creating these peaks and nulls at different points due to standing wave like effects as a result of the coherent detection by the separated ears. Thus this allows for quicker identification of source direction.

The typical worksite itself is to be considered. A study of the common audible spectral content for many worksites illustrates that there are relatively high sound pressure levels (SPLs) at the lower frequencies, generally below 700 Hz. This is noise which is generally attributed to the equipment itself and its movement. Using frequencies in this range would not add much value to the warning sounds generated, since the warnings would be masked out by ambient noise in the area. Furthermore, since a relatively significant portion of the workforce is older than 50 years, the well-established effects of hearing loss at higher frequencies suggests that it would not be beneficial to employ alarms at frequencies above 2800 Hz, since they may be out of the range of hearing for a significant fraction of the affected population. The SAE (Society of Automotive Engineers) has developed standards for warning alarms (SAE J994). Of particular note is that only alarms in the frequency range 700 Hz to 2800 Hz are recommended for use in these applications. The rational in the SAE document further supports the use of this frequency range.

### SUMMARY OF THE INVENTION

According to the invention, a multi-tone vehicle motion alarm is provided by imbedding in the alarm sound a plurality of band-limited single-tone acoustic signals of different frequencies that are emitted in pulsed synchronism so that the warning signal is emitted in a form that allows directionality of the source to be determined by those around the vehicle. This functional extension preserves many of the familiar aspects of existing alarms. Further, limiting the frequency band of the alarm reduces useless noise in the worksite. One embodiment emits a pulsating tone alarm that includes two discrete and identifiable monotones. Other embodiments may include many tones or a wider frequency band of sound. The pulsating tone alarm is an extension of widely recognized pulsating reverse warning sounds. Additional tones may be employed to aid in the speed with which the sound source can be located with human hearing. The present invention thus advances workplace safety while minimizing any unnecessary noise.

Combining the concept of multiple tones for better directional sensing and the usefulness of various frequencies for warning on a worksite, in accordance with the present invention, results in an alarm that produces tones of more than a single frequency, yet the sound is bounded on both ends of the frequency band to maximize the utility of the alarm without contributing to unnecessary workplace noise. In some embodiments, the alarm operates without frequency bounds.

The resultant system optimizes the usefulness of the warning alarm by building off of the widely recognized alarm sound pattern while adding additional frequency content, improving directional recognition, and containing the frequency content in the band of most use reducing useless workplace noise.

The invention will be better understood by reference to the following detailed description in connection with the accompanying drawings.

### BRIEF DESCRIPTION OF THE DRAWINGS

FIG. 1 is a block diagram of the circuit elements of a multi-tone alarm system, in accordance with one embodiment of the present the invention.

FIG. 2 is a block diagram a multi-tone alarm system having circuit elements disposed in a micro-controller, in accordance with another embodiment of the present invention.

FIG. 3 shows various blocks of an integrated circuit configured to generate a multitude of tones, in accordance with one embodiment of the present the invention.

### DETAILED DESCRIPTION OF SPECIFIC EMBODIMENTS

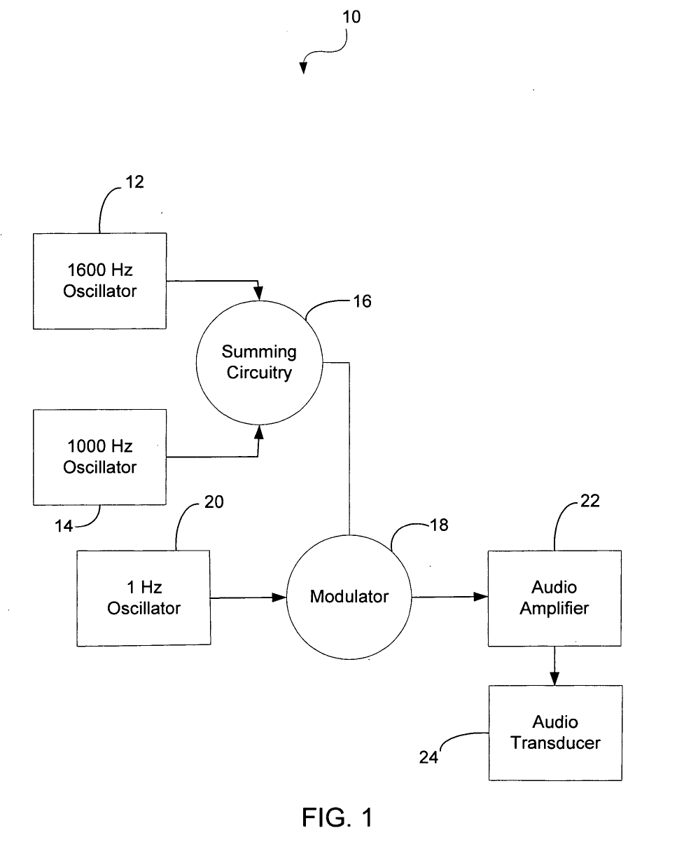

FIG. 1 is a simplified high-level diagram of various blocks disposed in alarm system 10, in accordance with one embodiment of the present invention. Alarm system 10 is shown as including, in part, two distinct signal generators 12, 14. In the exemplary embodiment shown in FIG. 1, one of the signal generators is shown as operating at 1000 Hz and the other is shown as operating at 1600 Hz. The frequency of such two tones two is generally selected per the SAE qualification, in order to maximize usefulness. The frequencies need to be far enough apart in range so that the difference in the respective wavelengths is noticeable to the human ear. The frequencies may or may not be harmonically related, as by a difference of a third or a fifth of an octave. Non-harmonic tones produce an unpleasant output but are more useful in determining source direction. The two tone signals supplied by tone generators 12 and 14 are mixed by summing circuit 16 such that the frequency spectral content of the mix tones includes two distinct peaks.

If more than two frequencies are mixed, the spectral content will contain more peaks. Due to a variety of phenomena, the spectral content may also contain other non-intended frequencies; however, this is not a functional problem and may be ignored so long as the fundamental signals are dominant.

The mixed output of summing circuit 16 is modulated by a modulator 18 which produces a repetitive pulse at a low frequency, in this exemplary embodiment 1 Hz, as excited by a 1 Hz oscillator 20. The modulator output is supplied to an audio amplifier 22. The output of audio amplifier 22 is subsequently supplied to an audio transducer, namely a point source loudspeaker 24 mounted on the alarmed equipment (not shown). The result of this is an on/off signal mimicking the “beep-beep” of the conventional safety alarm, but with a frequency content that allows a listener to more easily identify the direction from which the sound is emitted.

In one embodiment, modulator 18 is modulated by an oscillator having a frequency of 1 Hz with a 50 percent duty cycle. However, many variations are possible to obtain different effects in the sound of the alarm, ranging from varying the duty cycle or frequency to generating different sounds during sequential on cycles. The output of the modulator is input to amplifier 20 which amplifies the signal it receives and supplies the amplified signal output transducer 22.

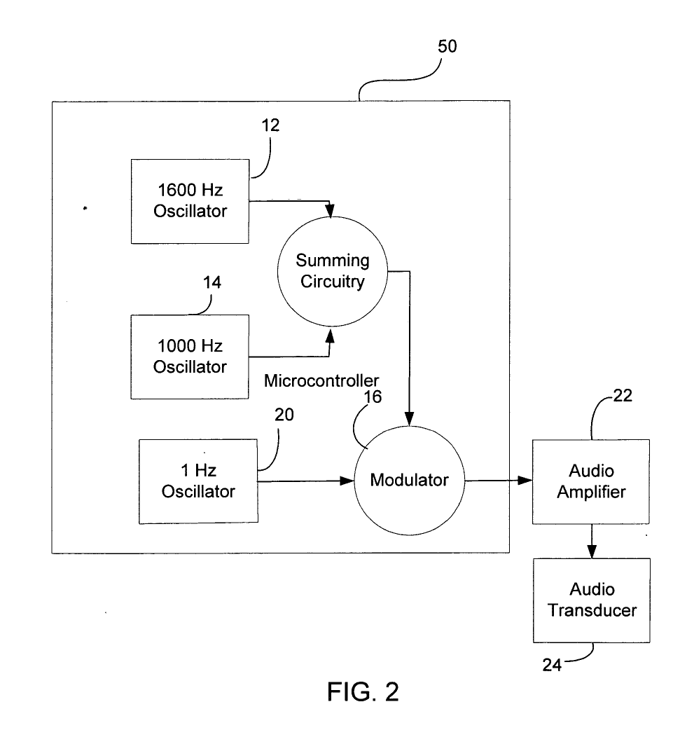

In some embodiments, the oscillators, the summing circuitry, as well as the modulator are disposed in a micro-controller, such as that shown in FIG. 2. Micro-controller 50 of FIG. 2 is shown as including signal generators 12, 14, summing circuitry 16, as well as oscillator 20 that generates a 1 Hz clock signal.

Variations on the design include various spectral content and modulations options as described above, including features for varying the output amplitude and frequency based on listening to the ambient noise. These variations may include adjusting the output amplitude to be some fixed amount above the ambient level. Another option is to change the frequency content based on ambient noise, or to change the on/off patterns based on a profile of variations in the ambient noise. For example if the ambient noise includes another pulsing backup alarm, the present invention contemplates an alarm at a different pulse rate and different frequency set within the allowable range.

The physical realization of the various embodiments can be in a conventional back-up alarm footprint utilizing basic speaker transducers. Alternatively, high output compression driver devices may be used. Other realizations may include warning systems used for a variety of transportation systems ranging from airports to buses. The warning technique according to the invention may also be used in conjunction with other types of warnings including voice and emergency sirens.

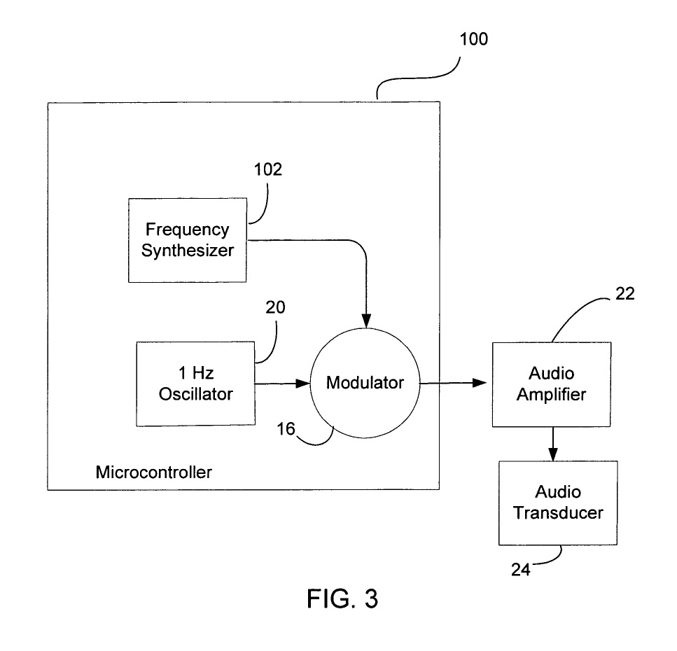

FIG. 3 shows various blocks of an integrated circuit (IC) 100 configured to generate a multitude of tones, in accordance with one embodiment of the present the invention. IC 100 is shown as including, in part, a frequency synthesizer 102, a 1 Hz oscillator 20, and a modulator 16. Audio amplifier 22 and audio transducer 24 are external to IC 100.

The above embodiments of the present invention are illustrative and not limiting. Various alternatives and equivalents are possible. The invention is not limited by the type of oscillators, summing circuitry, modulator, amplifier, and audio transducer. The invention is not limited by the type of integrated circuit used. Nor is the disclosure limited to any specific type of process technology, e.g., CMOS, Bipolar, or BICMOS that may be used to manufacture parts or the entirety of the present disclosure. Other additions, subtractions or modifications are obvious in view of the present disclosure and are intended to fall within the scope of the appended claims.

What is claimed is:

1. A multi-tone alarm for use in a workplace having vehicles requiring motion alarms comprising, the multi-tone alarm comprising:
a first single-tone generator adapted to generate a first tone;
a second single-tone generator adapted to generate a second tone;
a summing circuit adapted to receive and sum the first and second tones to generate a mixed tone;
a modulator operatively arranged to receive the mixed tone and to supply a modulated tone in response; and
an output source adapted to supply an output signal in response to the modulated signal.

2. The apparatus according to claim 1 wherein the first single-tone generator and the second single-tone generator are operative at a non-harmonically related frequencies.

3. The apparatus according to claim 2 wherein the first single-tone generator and the second single-tone generator are both adapted to supply tones between 700 Hz and 2800 Hz.

4. The apparatus according to claim 1 wherein the first single-tone generator and the second single-tone generator are both adapted to supply tones between 700 Hz and 2800 Hz.

5. The apparatus according to claim 1 further comprising:
an amplifier adapted to amplify the modulated signal and supply the amplified modulated signal to the output source.

6. A method of producing an audible alarm for use in a workplace having equipment requiring motion alarms, the method comprising:
generating a first single tone at a first frequency in a limited audible range;
generating a second single tone at a second frequency within the limited audible range;
modulating said first tone and said second tone synchronously to produce a synchronous multi-tone rhythmic output; and
emitting said multi-tone rhythmic output from a single source to a target area in order to promote standing wave sounds useful to a listener to identify source direction.

7. The method according to claim 6 wherein the first single-tone generator and the second single-tone generator are operative at a non-harmonically related frequencies.

8. The method according to claim 7 wherein the frequency of the first tone and the second tone are both between 700 Hz and 2800 Hz.

9. The method according to claim 6 wherein the frequency of the first tone and the second tone are both between 700 Hz and 2800 Hz.

10. An apparatus adapted to produce an audible alarm for use in a workplace having equipment requiring motion alarms, the apparatus comprising:
means for generating a first single tone at a first frequency in a limited audible range;
means for generating a second single tone at a second frequency within the limited audible range;
means for modulating said first tone and said second tone synchronously to produce a synchronous multi-tone rhythmic output; and
means for emitting said multi-tone rhythmic output from a single source to a target area in order to promote standing wave sounds useful to a listener to identify source direction.

11. The apparatus of claim 10 wherein the first single-tone generator and the second single-tone generator are operative at a non-harmonically related frequencies.

12. The apparatus of claim 11 wherein the frequency of the first tone and the second tone are both between 700 Hz and 2800 Hz.

13. The apparatus of claim 10 wherein the frequency of the first tone and the second tone are both between 700 Hz and 2800 Hz.

14. A multi-tone alarm for use in a workplace having vehicles requiring motion alarms, the multi-tone alarm comprising:
a micro-controller generating a complex waveform with multiple frequency components adapted to be modulated to be on and off in sequence;
an output source adapted to supply an output signal in response to the modulated signal to a target area in order to promote standing wave sounds useful to a listener to identify the output source location.

15. The apparatus of claim 14 wherein the frequency content is adapted to vary with time.

16. The apparatus of claim 15 further comprising:
circuitry adapted to vary the frequency content and volume of the standing wave sounds.
